(19) United States
(12) Patent Application Publication
(10) Pub. No.: US 2024/0298366 A1
(43) Pub. Date: Sep. 5, 2024

(54) SYSTEMS AND METHODS OF INDICATING MAPPING INFORMATION

(71) Applicant: Meta Platforms Technologies, LLC, Menlo Park, CA (US)

(72) Inventors: Muhammad Kumail Haider, Sunnyvale, CA (US); Binita Gupta, San Diego, CA (US); Chunyu Hu, Saratoga, CA (US)

(73) Assignee: Meta Platforms Technologies, LLC, Menlo Park, CA (US)

(21) Appl. No.: 18/426,836

(22) Filed: Jan. 30, 2024

Related U.S. Application Data
(60) Provisional application No. 63/449,795, filed on Mar. 3, 2023.

(51) Int. Cl. H04W 76/11; H04W 84/12; H04W 88/10

(52) U.S. Cl. CPC H04W 76/11; H04W 84/12; H04W 88/10

(57) ABSTRACT

A device within an access point multi-link device (AP MLD) having a plurality of wireless links may include one or more processors configured to generate a first frame including a first subfield. The first subfield may include a plurality of bits corresponding to the plurality of wireless links. Each bit may indicate whether a plurality of traffic identifiers (TIDs) are mapped to a corresponding wireless link. The device may wirelessly transmit, through a transmitter in a wireless local area network (WLAN), the first frame.

### CROSS-REFERENCE TO RELATED APPLICATION

This application claims priority to U.S. Provisional Patent Application No. 63/449,795 filed on Mar. 3, 2023, which is incorporated by reference herein in its entirety for all purposes.

### FIELD OF DISCLOSURE

The present disclosure is generally related to communications, including but not limited systems and methods of signaling TID (traffic identifier)-to-link mapping for an access point (AP) multilink device (MLD) to an associated non-AP MLD.

### BACKGROUND

Artificial reality such as virtual reality (VR), augmented reality (AR), or mixed reality (MR), provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space). An image of a virtual object may be generated by a console communicatively coupled to the HWD. In some embodiments, the console may have access to a network.

### SUMMARY

Various embodiments disclosed herein are related to a device within an access point multi-link device (AP MLD) having a plurality of wireless links, the device including one or more processors. The one or more processors may be configured to generate a first frame including a first subfield (e.g., the first subfield can include a plurality of bits corresponding to the plurality of wireless links, and each bit can indicate whether a plurality of traffic identifiers (TIDs) are mapped to a corresponding wireless link), and wirelessly transmit, through a transmitter in a wireless local area network (WLAN), the first frame.

In some embodiments, the first subfield may be included in a TID-to-link mapping information element (IE). In some embodiments, the first subfield may have a size of one octet representing a TID-to-link mapping for 8 wireless links, or a size of two octets representing a TID-to-link mapping for 16 wireless links.

In some embodiments, in generating the first frame, the one or more processors may be configured to enable a wireless link among the plurality of wireless links, and can set a bit, among the plurality of bits, corresponding to the enabled wireless link to a first value, indicating that one or more of the plurality of TIDs are mapped to the enabled wireless link.

In some embodiments, in generating the first frame, the one or more processors may be configured to set a bit among the plurality of bits, the bit corresponding to a wireless link among the plurality of wireless links, to a second value, indicating that no TIDs are mapped to the wireless links, wherein setting the bit to the second value is to disable the wireless link.

In some embodiments, the first subfield may be present when a first bit is set to 1. In some embodiments, the first frame may have a second subfield including the first bit.

In some embodiments, the second subfield may include a second bit, and the one or more processors may be configured to set the second bit to 1 to cause a device receiving the first frame to maintain a TID-to-link mapping that has been previously negotiated with an AP and does not conflict with the TID-to-link mapping indicated by the first subfield.

In some embodiments, in generating the first frame, the one or more processors may be configured to disable a wireless link among the plurality of wireless links, set a bit, among the plurality of bits, corresponding to the disabled wireless link to indicate that no TIDs are mapped to the disabled wireless link, and/or set the second bit to 1 to cause the device receiving the first frame to maintain a TID-to-link mapping on remaining wireless links that do not include the disabled wireless link.

In some embodiments, the first frame may cause the device receiving the first frame not to renegotiate a TID-to-link mapping with the AP. In some embodiments, in generating the first frame, the one or more processors may be configured to disable a wireless link among the plurality of wireless links, set a bit, among the plurality of bits, corresponding to the disabled wireless link to indicate that no TIDs are mapped to the disabled wireless link, and/or set the second bit to 0 to cause the device receiving the first frame to renegotiate a TID-to-link mapping with the AP based on the TID-to-link mapping indicated by the first subfield.

Various embodiments disclosed herein are related to a method. The method may include generating, by a device within an access point multi-link device (AP MLD) having a plurality of wireless links, a first frame including a first subfield (e.g., the first subfield can include a plurality of bits corresponding to the plurality of wireless links, and each bit may indicate whether a plurality of traffic identifiers (TIDs) are mapped to a corresponding wireless link), and wirelessly transmitting, by the device through a transmitter in a wireless local area network (WLAN), the first frame.

In some embodiments, the first subfield may be included in a TID-to-link mapping information element (IE). In some embodiments, the first subfield may have a size of one octet representing a TID-to-link mapping for 8 wireless links, or a size of two octets representing a TID-to-link mapping for 16 wireless links.

In some embodiments, the generating the first frame may include enabling a wireless link among the plurality of wireless links, and/or setting a bit, among the plurality of bits, corresponding to the enabled wireless link to a first value, which can indicate that one or more of the plurality of TIDs are mapped to the enabled wireless link.

In some embodiments, the generating the first frame may include setting a bit among the plurality of bits, the bit corresponding to a wireless link among the plurality of wireless links, to a second value, indicating that no TIDs are mapped to the wireless links, wherein setting the bit to the second value is to disable the wireless link.

In some embodiments, the first subfield may be present when a first bit is set to 1. In some embodiments, the first frame may have a second subfield including the first bit.

In some embodiments, the second subfield may include a second bit, and the method may further include setting the second bit to 1 to cause a device receiving the first frame to maintain a TID-to-link mapping that has been previously negotiated with an AP and does not conflict with the TID-to-link mapping indicated by the first subfield.

In some embodiments, the generating the first frame may include disabling a wireless link among the plurality of wireless links, setting a bit, among the plurality of bits, corresponding to the disabled wireless link to indicate that no TIDs are mapped to the disabled wireless link, and/or setting the second bit to 1 to cause the device receiving the first frame to maintain a TID-to-link mapping on remaining wireless links that do not include the disabled wireless link.

In some embodiments, the first frame may cause the device receiving the first frame not to renegotiate a TID-to-link mapping with the AP. In some embodiments, the generating the first frame may include disabling a wireless link among the plurality of wireless links, setting a bit, among the plurality of bits, corresponding to the disabled wireless link to indicate that no TIDs are mapped to the disabled wireless link, and/or setting the second bit to 0 to cause the device receiving the first frame to renegotiate a TID-to-link mapping with the AP based on the TID-to-link mapping indicated by the first subfield.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of an example configuration of an access point multi-link device (AP MLD) and a non-AP MLD, according to an example implementation of the present disclosure.

FIG. 5A is an example field format of a TID-To-Link Mapping element for indicating mapping information, according to an example implementation of the present disclosure.

FIG. 5B is an example field format of a TID-to-Link Mapping Control field of the TID-To-Link Mapping element, according to an example implementation of the present disclosure.

FIG. 6A is an example field format of a TID-To-Link Mapping element for indicating mapping information, according to an example implementation of the present disclosure.

FIG. 6B is an example field format of a TID-to-Link Mapping Control field of the TID-To-Link Mapping element, according to an example implementation of the present disclosure.

FIG. 7A is an example field format of a TID-To-Link Mapping element for indicating mapping information, according to an example implementation of the present disclosure.

FIG. 7B is an example field format of a TID-to-Link Mapping Control field of the TID-To-Link Mapping element, according to an example implementation of the present disclosure.

FIG. 8 is a flowchart showing a method of indicating mapping information, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

### 1. Example Configuration of Artificial Reality Systems

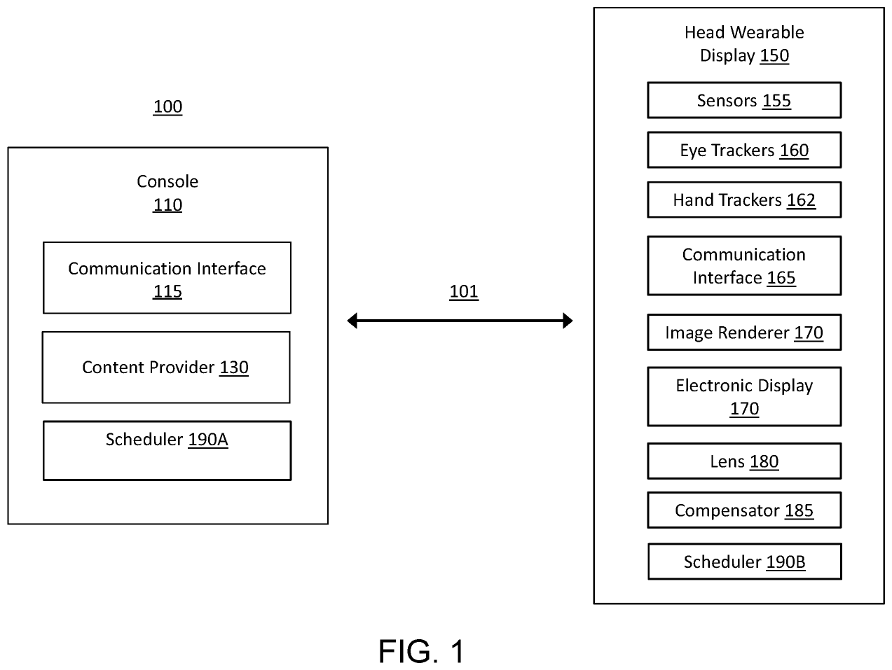

FIG. 1 is a block diagram of an example artificial reality system environment 100 in which a console 110 operates. FIG. 1 provides an example environment in which devices may communicate traffic streams with different latency sensitivities/requirements. In some embodiments, the artificial reality system environment 100 includes a HWD 150 worn by a user, and a console 110 providing content of artificial reality to the HWD 150. A head wearable display (HWD) may be referred to as, include, or be part of a head mounted display (HMD), head mounted device (HMD), head wearable device (HWD), head worn display (HWD) or head worn device (HWD). In one aspect, the HWD 150 may include various sensors to detect a location, an orientation, and/or a gaze direction of the user wearing the HWD 150, and provide the detected location, orientation and/or gaze direction to the console 110 through a wired or wireless connection. The HWD 150 may also identify objects (e.g., body, hand face).

The console 110 may determine a view within the space of the artificial reality corresponding to the detected location, orientation and/or the gaze direction, and generate an image depicting the determined view. The console 110 may also receive one or more user inputs and modify the image according to the user inputs. The console 110 may provide the image to the HWD 150 for rendering. The image of the space of the artificial reality corresponding to the user's view can be presented to the user. In some embodiments, the artificial reality system environment 100 includes more, fewer, or different components than shown in FIG. 1. In some embodiments, functionality of one or more components of the artificial reality system environment 100 can be distributed among the components in a different manner than is described here. For example, some of the functionality of the console 110 may be performed by the HWD 150, and/or some of the functionality of the HWD 150 may be performed by the console 110.

In some embodiments, the HWD 150 is an electronic component that can be worn by a user and can present or provide an artificial reality experience to the user. The HWD 150 may render one or more images, video, audio, or some combination thereof to provide the artificial reality experience to the user. In some embodiments, audio is presented via an external device (e.g., speakers and/or headphones) that receives audio information from the HWD 150, the console 110, or both, and presents audio based on the audio information. In some embodiments, the HWD 150 includes sensors 155, eye trackers 160, a communication interface 165, an image renderer 170, an electronic display 175, a lens 180, and a compensator 185. These components may operate together to detect a location of the HWD 150 and/or a gaze direction of the user wearing the HWD 150, and render an image of a view within the artificial reality corresponding to the detected location of the HWD 150 and/or the gaze direction of the user. In other embodiments, the HWD 150 includes more, fewer, or different components than shown in FIG. 1.

In some embodiments, the sensors 155 include electronic components or a combination of electronic components and software components that detect a location and/or an orientation of the HWD 150. Examples of sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and/or the rotational movement, and determine an orientation and location of the HWD 150. In one aspect, the sensors 155 can detect the translational movement and/or the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the eye trackers 160 include electronic components or a combination of electronic components and software components that determine a gaze direction of the user of the HWD 150. In some embodiments, the HWD 150, the console 110 or a combination may incorporate the gaze direction of the user of the HWD 150 to generate image data for artificial reality. In some embodiments, the eye trackers 160 include two eye trackers, where each eye tracker 160 captures an image of a corresponding eye and determines a gaze direction of the eye. In one example, the eye tracker 160 determines an angular rotation of the eye, a translation of the eye, a change in the torsion of the eye, and/or a change in shape of the eye, according to the captured image of the eye, and determines the relative gaze direction with respect to the HWD 150, according to the determined angular rotation, translation and the change in the torsion of the eye. In one approach, the eye tracker 160 may shine or project a predetermined reference or structured pattern on a portion of the eye, and capture an image of the eye to analyze the pattern projected on the portion of the eye to determine a relative gaze direction of the eye with respect to the HWD 150. In some embodiments, the eye trackers 160 incorporate the orientation of the HWD 150 and the relative gaze direction with respect to the HWD 150 to determine a gaze direction of the user. Assuming for an example that the HWD 150 is oriented at a direction 30 degrees from a reference direction, and the relative gaze direction of the HWD 150 is −10 degrees (or 350 degrees) with respect to the HWD 150, the eye trackers 160 may determine that the gaze direction of the user is 20 degrees from the reference direction. In some embodiments, a user of the HWD 150 can configure the HWD 150 (e.g., via user settings) to enable or disable the eye trackers 160. In some embodiments, a user of the HWD 150 is prompted to enable or disable the eye trackers 160.

In some embodiments, the hand tracker 162 includes an electronic component or a combination of an electronic component and a software component that tracks a hand of the user. In some embodiments, the hand tracker 162 includes or is coupled to an imaging sensor (e.g., camera) and an image processor that can detect a shape, a location and/or an orientation of the hand. The hand tracker 162 may generate hand tracking measurements indicating the detected shape, location and/or orientation of the hand.

In some embodiments, the communication interface 165 includes an electronic component or a combination of an electronic component and a software component that communicates with the console 110. The communication interface 165 may communicate with a communication interface 115 of the console 110 through a communication link. The communication link may be a wireless link, a wired link, or both. Examples of the wireless link can include a cellular communication link, a near field communication link, Wi-Fi, Bluetooth, or any communication wireless communication link. Examples of the wired link can include a USB, Ethernet, Firewire, HDMI, or any wired communication link. In embodiments in which the console 110 and the head wearable display 150 are implemented on a single system, the communication interface 165 may communicate with the console 110 through a bus connection or a conductive trace. Through the communication link, the communication interface 165 may transmit to the console 110 sensor measurements indicating the determined location of the HWD 150, orientation of the HWD 150, the determined gaze direction of the user, and/or hand tracking measurements. Moreover, through the communication link, the communication interface 165 may receive from the console 110 sensor measurements indicating or corresponding to an image to be rendered.

Using the communication interface, the console 110 (or HWD 150) may coordinate operations on link 101 to reduce collisions or interferences. For example, the console 110 may coordinate communication between the console 110 and the HWD 150. In some implementations, the console 110 may transmit a beacon frame periodically to announce/advertise a presence of a wireless link between the console 110 and the HWD 150 (or between two HWDs). In an implementation, the HWD 150 may monitor for or receive the beacon frame from the console 110, and can schedule communication with the HWD 150 (e.g., using the information in the beacon frame, such as an offset value) to avoid collision or interference with communication between the console 110 and/or HWD 150 and other devices.

The console 110 and HWD 150 may communicate using link 101 (e.g., intralink). Data (e.g., a traffic stream) may flow in a direction on link 101. For example, the console 110 may communicate using a downlink (DL) communication to the HWD 150 and the HWD 150 may communicate using an uplink (UL) communication to the console 110.

In some embodiments, the image renderer 170 includes an electronic component or a combination of an electronic component and a software component that generates one or more images for display, for example, according to a change in view of the space of the artificial reality. In some embodiments, the image renderer 170 is implemented as a processor (or a graphical processing unit (GPU)) that executes instructions to perform various functions described herein. The image renderer 170 may receive, through the communication interface 165, data describing an image to be rendered, and render the image through the electronic display 175. In some embodiments, the data from the console 110 may be encoded, and the image renderer 170 may decode the data to generate and render the image. In one aspect, the image renderer 170 receives the encoded image from the console 110, and decodes the encoded image, such that a communication bandwidth between the console 110 and the HWD 150 can be reduced.

In some embodiments, the image renderer 170 receives, from the console, 110 additional data including object information indicating virtual objects in the artificial reality space and depth information indicating depth (or distances from the HWD 150) of the virtual objects. Accordingly, the image renderer 170 may receive from the console 110 object information and/or depth information. The image renderer 170 may also receive updated sensor measurements from the sensors 155. The process of detecting, by the HWD 150, the location and the orientation of the HWD 150 and/or the gaze direction of the user wearing the HWD 150, and generating and transmitting, by the console 110, a high resolution image (e.g., 1920 by 1080 pixels, or 2048 by 1152 pixels) corresponding to the detected location and the gaze direction to the HWD 150 may be computationally exhaustive and may not be performed within a frame time (e.g., less than 11 ms or 8 ms).

In some implementations, the image renderer 170 may perform shading, reprojection, and/or blending to update the image of the artificial reality to correspond to the updated location and/or orientation of the HWD 150. Assuming that a user rotated their head after the initial sensor measurements, rather than recreating the entire image responsive to the updated sensor measurements, the image renderer 170 may generate a small portion (e.g., 10%) of an image corresponding to an updated view within the artificial reality according to the updated sensor measurements, and append the portion to the image in the image data from the console 110 through reprojection. The image renderer 170 may perform shading and/or blending on the appended edges. Hence, without recreating the image of the artificial reality according to the updated sensor measurements, the image renderer 170 can generate the image of the artificial reality.

In other implementations, the image renderer 170 generates one or more images through a shading process and a reprojection process when an image from the console 110 is not received within the frame time. For example, the shading process and the reprojection process may be performed adaptively, according to a change in view of the space of the artificial reality.

In some embodiments, the electronic display 175 is an electronic component that displays an image. The electronic display 175 may, for example, be a liquid crystal display or an organic light emitting diode display. The electronic display 175 may be a transparent display that allows the user to see through. In some embodiments, when the HWD 150 is worn by a user, the electronic display 175 is located proximate (e.g., less than 3 inches) to the user's eyes. In one aspect, the electronic display 175 emits or projects light towards the user's eyes according to image generated by the image renderer 170.

In some embodiments, the lens 180 is a mechanical component that alters received light from the electronic display 175. The lens 180 may magnify the light from the electronic display 175, and correct for optical error associated with the light. The lens 180 may be a Fresnel lens, a convex lens, a concave lens, a filter, or any suitable optical component that alters the light from the electronic display 175. Through the lens 180, light from the electronic display 175 can reach the pupils, such that the user can see the image displayed by the electronic display 175, despite the close proximity of the electronic display 175 to the eyes.

In some embodiments, the compensator 185 includes an electronic component or a combination of an electronic component and a software component that performs compensation to compensate for any distortions or aberrations. In one aspect, the lens 180 introduces optical aberrations such as a chromatic aberration, a pin-cushion distortion, barrel distortion, etc. The compensator 185 may determine a compensation (e.g., predistortion) to apply to the image to be rendered from the image renderer 170 to compensate for the distortions caused by the lens 180, and apply the determined compensation to the image from the image renderer 170. The compensator 185 may provide the predistorted image to the electronic display 175.

In some embodiments, the console 110 is an electronic component or a combination of an electronic component and a software component that provides content to be rendered to the HWD 150. In one aspect, the console 110 includes a communication interface 115 and a content provider 130. These components may operate together to determine a view (e.g., a field of view (FOV) of the user) of the artificial reality corresponding to the location of the HWD 150 and/or the gaze direction of the user of the HWD 150, and can generate an image of the artificial reality corresponding to the determined view. In other embodiments, the console 110 includes more, fewer, or different components than shown in FIG. 1. In some embodiments, the console 110 is integrated as part of the HWD 150. In some embodiments, the communication interface 115 is an electronic component or a combination of an electronic component and a software component that communicates with the HWD 150. The communication interface 115 may be a counterpart component to the communication interface 165 to communicate with a communication interface 115 of the console 110 through a communication link (e.g., USB cable, a wireless link). Through the communication link, the communication interface 115 may receive from the HWD 150 sensor measurements indicating the determined location and/or orientation of the HWD 150, the determined gaze direction of the user, and/or hand tracking measurements. Moreover, through the communication link, the communication interface 115 may transmit to the HWD 150 data describing an image to be rendered.

The content provider 130 can include or correspond to a component that generates content to be rendered according to the location and/or orientation of the HWD 150, the gaze direction of the user and/or hand tracking measurements. In one aspect, the content provider 130 determines a view of the artificial reality according to the location and orientation of the HWD 150 and/or the gaze direction of the user of the HWD 150. For example, the content provider 130 maps the location of the HWD 150 in a physical space to a location within an artificial reality space, and determines a view of the artificial reality space along a direction corresponding to an orientation of the HWD 150 and/or the gaze direction of the user from the mapped location in the artificial reality space.

The content provider 130 may generate image data describing an image of the determined view of the artificial reality space, and transmit the image data to the HWD 150 through the communication interface 115. The content provider may also generate a hand model (or other virtual object) corresponding to a hand of the user according to the hand tracking measurement, and generate hand model data indicating a shape, a location, and an orientation of the hand model in the artificial reality space.

In some embodiments, the content provider 130 generates metadata including motion vector information, depth information, edge information, object information, etc., associated with the image, and transmits the metadata with the image data to the HWD 150 through the communication interface 115. The content provider 130 may encode and/or encode the data describing the image, and can transmit the encoded and/or encoded data to the HWD 150. In some embodiments, the content provider 130 generates and provides the image to the HWD 150 periodically (e.g., every one second).

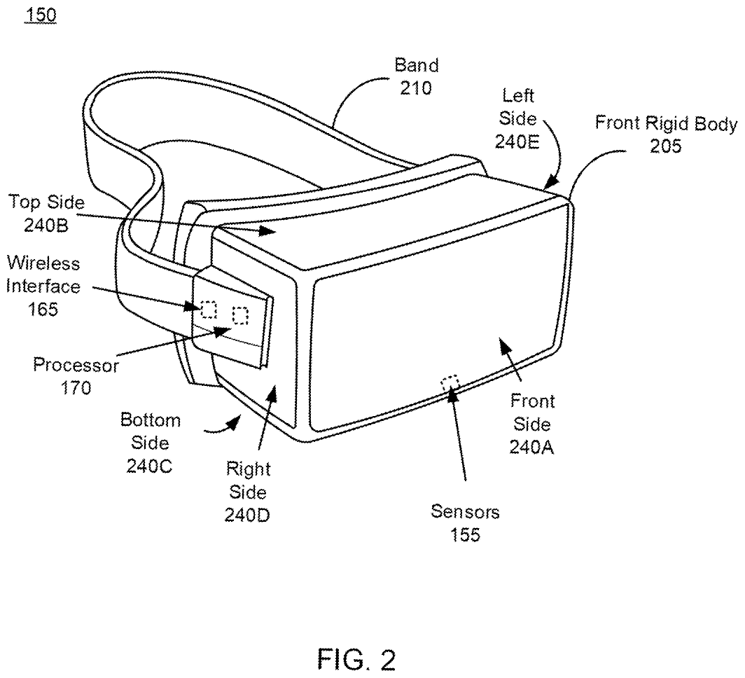

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens 180 (not shown in FIG. 2), the sensors 155, the eye trackers 160A, 160B, the communication interface 165, and the image renderer 170. In the embodiment shown by FIG. 2, the sensors 155 are located within the front rigid body 205, and may not visible to the user. In other embodiments, the HWD 150 has a different configuration than shown in FIG. 2. For example, the image renderer 170, the eye trackers 160A, 160B, and/or the sensors 155 may be in different locations than shown in FIG. 2.

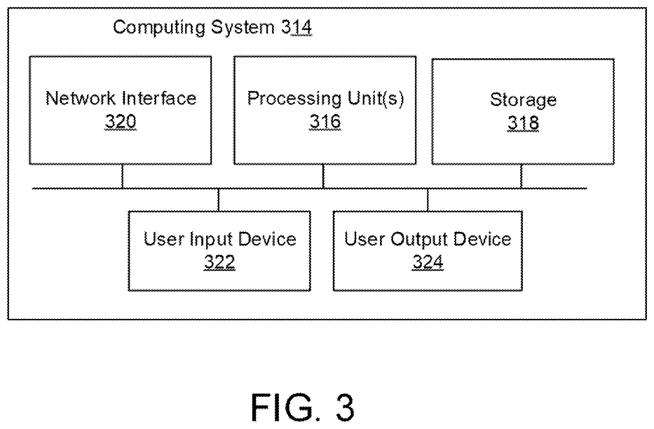

Various operations described herein can be implemented on computer systems. FIG. 3 shows a block diagram of a representative computing system 314 usable to implement the present disclosure. In some embodiments, the console 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 320 may include a transceiver to allow the computing system 314 to transmit and receive data from a remote device (e.g., an AP, a STA) using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 316. Similarly, a receiver may be configured to receive frames, slots or symbols and the processor unit 316 may be configured to process the frames. For example, the processor unit 316 can be configured to determine a type of frame and to process the frame and/or fields of the frame accordingly.

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

### 2. Example Configuration of Artificial Reality Systems

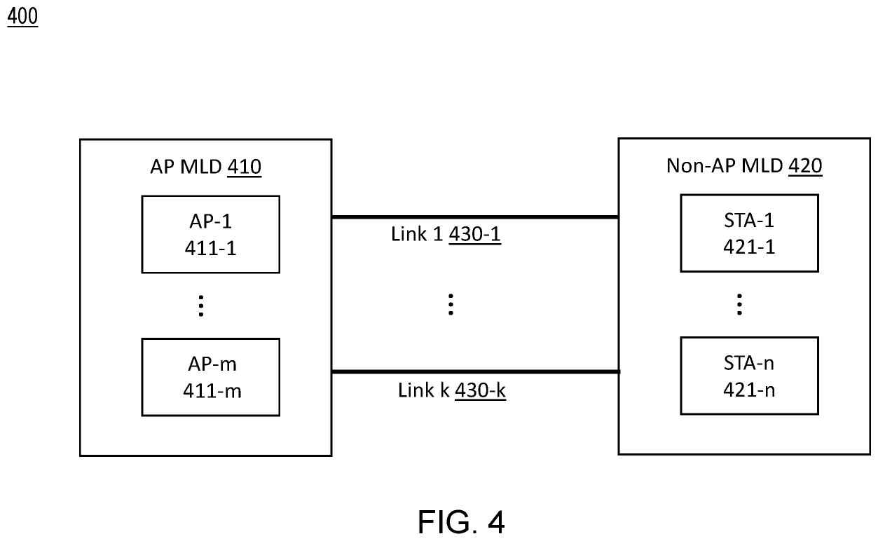

FIG. 4 is a block diagram of an example configuration 400 of an access point multi-link device (AP MLD) 410, a non-AP MLD 420, and a plurality of links (e.g., k links or channels 430-1, . . . , 430-k where k is an integer greater than 1), according to an example implementation of the present disclosure. The AP MLD 410 may include a first AP device (or first AP) 411-1 (e.g., first AP radio transceiver; “AP-1” in FIG. 4), . . . , and an m^{th} AP device (or mi AP) 411-m (e.g., m^{th} AP radio transceiver; “AP-m” in FIG. 4), where m is an integer greater than 1. Each of the first-to-m^{th} devices may have a 1×1 radio or 2×2 radio. Similarly, the non-AP MLD 420 may include a first STA device (or first STA) 421-1 (e.g., first STA radio transceiver; “STA-1” in FIG. 4), . . . , and an n^{th} STA device (or n^{th} STA) 421-n (e.g., n^{th} STA radio transceiver; “STA-n” in FIG. 4), where n is an integer greater than 1. Each of the first-to-n STA devices may be a 1×1 radio or 2×2 radio. Each AP device of the AP MLD 410 may be associated with one or two links of the plurality of links to transmit or receive one or more frames to/from a corresponding STA device of the non-AP MLD 420. Similarly, each STA device of the non-AP MLD 420 may be associated with one or two links of the plurality of links to transmit or receive one or more frames to/from a corresponding AP device of the AP MLD 410.

### 3. TID-To-Link Mapping Element Format

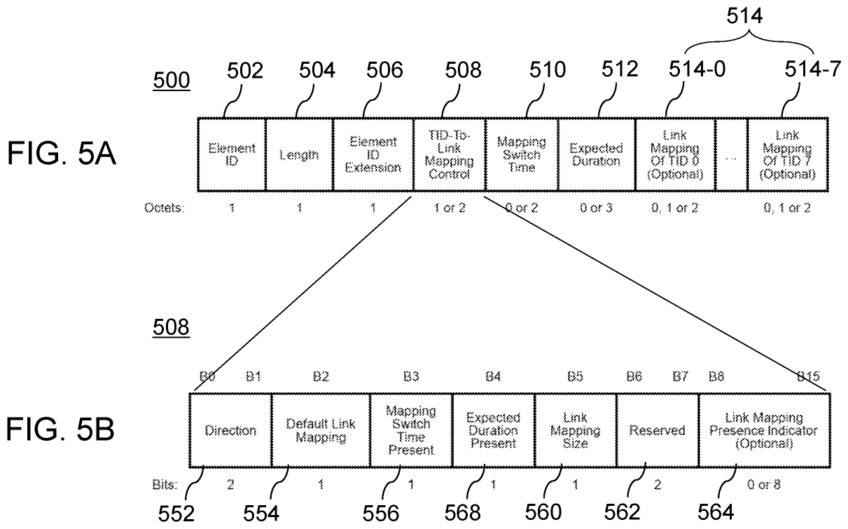

FIG. 5A is an example field format of a TID-To-Link Mapping element 500 for indicating mapping information, according to an example implementation of the present disclosure. FIG. 5B is an example field format of a TID-to-Link Mapping Control field 508 of the TID-To-Link Mapping element 500, according to an example implementation of the present disclosure. For example, the TID-To-Link Mapping element 500 can indicate a mapping of the k links shown in FIG. 4 with respect to TIDs. As shown in FIG. 5A, the TID-To-Link Mapping element 500 includes fields of Element ID 502, Length 504, Element ID Extension 506, TID-To-Link Mapping Control 508, Mapping Switch Time 510, Expected Duration 512, and/or Link Mapping Of TID 514 (e.g., including Link Mapping Of TID 0 (Optional) 514-0, . . . Link Mapping Of TID 7 (Optional) 514-7). As shown in FIG. 5B, the TID-to-Link Mapping Control field 508 includes subfields of Direction 552, Default Link Mapping 554, Mapping Switch Time Present 556, Expected Duration Present 558, Link Mapping Size 560, Reserved 562, and/or Link Mapping Presence Indicator (Optional) 564. At least one of the fields or the subfields may be omitted.

In some embodiments, the Element ID field 502 can be or include a numerical identifier to specify a type or category of information contained in the TID-To-Link Mapping element 500. In some embodiments, the Length field 504 can include a size or length of the TID-To-Link Mapping element 500. For example, the Length field 504 can specify a number of octets following the Length field 504 or contained in the TID-To-Link Mapping element 500. In some embodiments, the Element ID Extension field 506 can include an additional identifier or space therefor of the TID-To-Link Mapping element 500. In some embodiments, the Mapping Switch Time field 510 can include a time duration for a mapping switch to occur. In some embodiments, the Expected Duration field 512 can include an anticipated time duration for a mapping configuration or link association. For example, the Expected Duration field 512 can indicate an expected time for a specific TID-to-Link mapping. In some embodiments, the Link Mapping Of TID fields 514 can include mapping information about how TIDs are associated with links. For example, the Link Mapping Of TID fields 514 can indicate a mapping of the k links shown in FIG. 4 with respect to TIDs.

In some embodiments, the TID-To-Link Mapping Control field 508 can include control information for a TID-to-Link mapping configuration, including the subfields of Direction 552, Default Link Mapping 554, Mapping Switch Time Present 556, Expected Duration Present 558, Link Mapping Size 560, Reserved 562, and Link Mapping Presence Indicator (Optional) 564.

In some embodiments, the Direction subfield 552 can include whether the TID-To-Link Mapping element 500 provides mapping information for frames transmitted on a downlink (DL), an uplink (UL), or both. For example, the Direction subfield 552 can be set to “0” if the TID-To-Link Mapping element 500 provides the mapping information for frames transmitted on the DL. For example, the Direction subfield 552 can be set to “1” if the TID-To-Link Mapping element 500 provides the mapping information for frames transmitted on the UL. For example, the Direction subfield 552 can be set to “2” if the TID-To-Link Mapping element 500 provides the mapping information for frames transmitted both on the DL and the UL.

In some embodiments, the Default Link Mapping subfield 554 can be set to “1” if the TID-To-Link Mapping element 500 represents a default mapping. Otherwise, the Default Link Mapping subfield 554 can be set to “0.” In some embodiments, the Mapping Switch Time Present subfield 556 can be set to “1” if the Mapping Switch Time field 510 is present. Otherwise, the Mapping Switch Time Present subfield 556 can be set to “0.” In some embodiments, the Expected Duration Present subfield 558 can be set to “1” if the Expected Duration field 512 is present. Otherwise, the Expected Duration Present 558 can be set to “0.”

In some embodiments, the Link Mapping Size subfield 560 can be set to “1” if a length of the Link Mapping Of TID fields 514 is one octet, and can be set to “0” if the length of the Link Mapping Of TID fields 514 is two octets. In some embodiments, the TID-To-Link Mapping Control field 508 can include the Reserved subfield 562 to be further specified (e.g., in the future for various purposes).

In some embodiments, the Link Mapping Presence Indicator subfield 564 can include whether the Link Mapping Of TID fields 514 are present in the TID-To-Link Mapping element 500 (e.g., the Link Mapping Presence Indicator subfield 564 may identify TID(s) for which a mapping is provided in the TID-To-Link Mapping element 500). For example, a first value (e.g., 1) can be set to a n-th bit of the Link Mapping Presence Indicator subfield 564 to indicate that a n-th field of the Link Mapping Of TID fields 514 (e.g., the field for Link Mapping of TID n 514-n) is present in the TID-To-Link Mapping element 500. Otherwise, the Link Mapping Of TID fields 514 are not present in the TID-To-Link Mapping element 500. In some embodiments, when the Default Link Mapping subfield 554 is set to “1,” the Link Mapping Presence Indicator subfield 564 may be omitted.

The fields and/or subfields discussed herein can be configured in various manners to indicate mapping information. In some embodiments, the TID-To-link Mapping element 500 carries eight fields for Link Mapping of TID 514 in a Beacon frame to indicate mapping information. For example, when a mapping is updated (e.g., a disabled link, an enabled link, etc.), the TID-To-link Mapping element 500 carries the eight fields for Link Mapping of TID 514 in the Beacon frame to update the mapping information (e.g., to indicate that a link has been disabled/enabled). However, this can increase a size of the Beacon frame by 8 or 16 octets, thereby increasing an overhead and causing delays in a network. Furthermore, this can cause channel congestion, especially in scenarios with many APs, resulting in an increase in power consumption and a decline in an overall network throughput. In addition, the Beacon frame size should be kept as small as possible to avoid interop issues for legacy devices.

### 4. Enhanced TID-To-Link Mapping Element Format

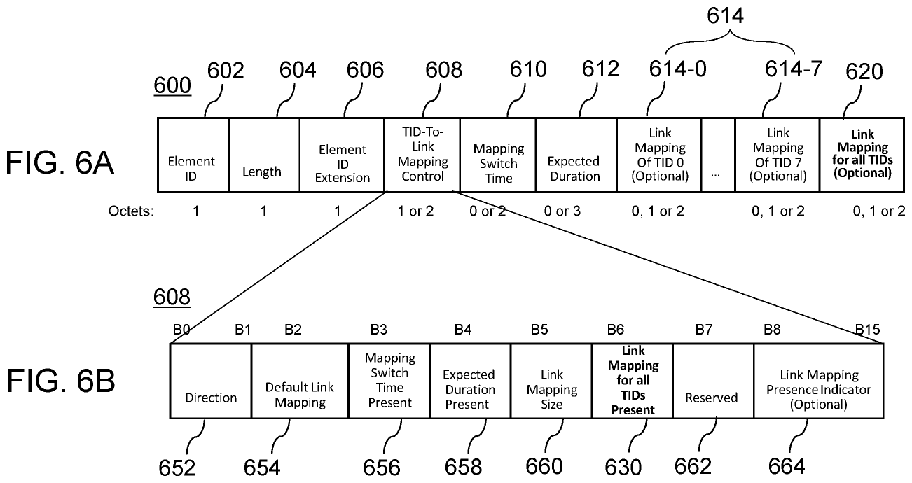

FIG. 6A is an example field format of a TID-To-Link Mapping element 600 for indicating mapping information, according to an example implementation of the present disclosure. FIG. 6B is an example field format of a TID-to-Link Mapping Control field 608 of the TID-To-Link Mapping element 600, according to an example implementation of the present disclosure. As shown in FIG. 6A, the TID-To-Link Mapping element 600 includes fields of Element ID 602, Length 604, Element ID Extension 606, TID-To-Link Mapping Control 608, Mapping Switch Time 610, Expected Duration 612, and/or Link Mapping Of TID 614 (e.g., including Link Mapping Of TID 0 (Optional) 614-0, . . . Link Mapping Of TID 7 (Optional) 614-7). As shown in FIG. 6B, the TID-to-Link Mapping Control field 608 includes subfields of Direction 652, Default Link Mapping 654, Mapping Switch Time Present 656, Expected Duration Present 658, Link Mapping Size 660, Reserved 662, and/or Link Mapping Presence Indicator (Optional) 664. At least one of the fields or the subfields may be omitted. The TID-To-Link Mapping element 600 and the TID-to-Link Mapping Control field 608 are non-limiting examples.

As shown in FIG. 6A, in some embodiments, the TID-To-Link Mapping element 600 can additionally include a field of Link Mapping for all TIDs (Optional) 620 (e.g., compared to the TID-To-Link Mapping element 500). As shown in FIG. 6B, in some embodiments, the TID-To-Link Mapping Control field 608 of the TID-To-Link Mapping element 600 can additionally include a field of Link Mapping for all TIDs Present 630 (e.g., compared to the TID-To-Link Mapping Control field 508).

The fields and/or subfields discussed herein can be configured in various manners to enhance an indication of the mapping information in a Beacon frame. In some embodiments, as shown in FIG. 6A and FIG. 6B, at least one of the TID-To-Link Mapping Control field 608, the Link Mapping for all TIDs field 620, or the Link Mapping for all TIDs Present subfield 630 can be configured, reconfigured, and/or added to enhance an indication of the mapping information in a Beacon frame.

In some embodiments, a device (e.g., AP-1 411-1) within an AP MLD (e.g., AP MLD 410) having a plurality of wireless links (e.g., Link 1 430-1, . . . , Link k 430-k) can be configured to indicate mapping information based on the TID-To-Link Mapping element 600. In some embodiments, the device can wirelessly transmit, through a transmitter in a wireless local area network (WLAN), a Beacon frame including the mapping information. As discussed in greater detail below, the Beacon frame can be configured in various manners to indicate the mapping information.

In some embodiments, the device can generate a Beacon frame, which may be or include the TID-To-Link Mapping element 600. The Beacon frame can include a field for Link Mapping for all TIDs 620. In some embodiments, the field for Link Mapping for all TIDs 620 can indicate whether a plurality of TIDs are mapped to a plurality of wireless links (e.g., the k links in FIG. 4). For example, the field for Link Mapping for all TIDs 620 can include a plurality of bits corresponding to the plurality of wireless links, respectively. Each bit can indicate whether one or more of the TIDs are mapped to a wireless link corresponding to the bit. For example, when one or more of the TIDs are mapped to a first link (e.g., Link 1 430-1), a first bit of the plurality of bits in the field for Link Mapping for all TIDs 620 can be set to “1.” For example, when none of the TIDs is mapped to the first link (e.g., Link 1 430-1), the first bit of the plurality of bits in the field for Link Mapping for all TIDs 620 can be set to “0.” For example, when one or more of the TIDs are mapped to a k-th link (e.g., Link k 430-k), a k-th bit of the plurality of bits in the field for Link Mapping for all TIDs 620 can be set to “1.” For example, when none of the TIDs is mapped to the k-th link (e.g., Link k 430-k), the k-th bit of the plurality of bits in the field for Link Mapping for all TIDs 620 can be set to “0.” In some embodiments, each bit can be set to “0” or “1” in response to a status of a corresponding link. For example, when a status of a link changes, a corresponding bit can be set to a new value. For example, when a link is enabled, a corresponding bit can be set to “1.” For example, a corresponding bit can be set to “0” to disable the link.

In some embodiments, the TID-To-Link Mapping element 600 may be or include a TID-to-link mapping information element (IE), which can include the field for Link Mapping for all TIDs 620. For example, the TID-to-link mapping IE can include the plurality of bits to indicate whether a plurality of TIDs are mapped to a plurality of wireless links, as discussed above.

In some embodiments, the field for Link Mapping for all TIDs 620 can have a size of one octet representing a TID-to-link mapping for 8 wireless links. Each bit of the one octet can correspond to a corresponding one of the eight wireless links, and can indicate whether one or more TIDs are mapped to the link. In some embodiments, the field for Link Mapping for all TIDs 620 can have a size of two octets representing a TID-to-link mapping for 16 wireless links. Each bit of the two octets can correspond to a corresponding one of the sixteen wireless links, and can indicate whether one or more TIDs are mapped to the link.

In some embodiments, the device can enable a wireless link among the plurality of wireless links, and can set a bit (e.g., among the plurality of bits in the field for Link Mapping for all TIDs 620) corresponding to the enabled wireless link to a first value. For example, the device can set the corresponding bit to “1” to indicate that one or more TIDs are mapped to the wireless link. For example, the device can set the corresponding bit to “1” to indicate that all the TIDs are mapped to the wireless link.

In some embodiments, the device can set a bit (e.g., among the plurality of bits in the field for Link Mapping for all TIDs 620), the bit corresponding to a wireless link among the plurality of wireless links, to a second value, indicating that no TIDs are mapped to the wireless links, wherein setting the bit to the second value can disable the wireless link. For example, the device can set the corresponding bit to “0” to indicate that none of TIDs is mapped to the wireless link and can disable the wireless link.

In some embodiments, the Link Mapping for all TIDs Present subfield 630 can include whether the Link Mapping for all TIDs field 620 is present or not. In some embodiments, a Beacon frame can include the TID-To-Link Mapping Control field 608, which can include the Link Mapping for all TIDs Present subfield 630 (e.g., a bit). For example, the Link Mapping for all TIDs field 620 may be present when a bit of the Link Mapping for all TIDs Present subfield 630 is set to “1.” For example, the Link Mapping for all TIDs field 620 may be omitted when the bit of the Link Mapping for all TIDs Present subfield 630 is set to “0.”

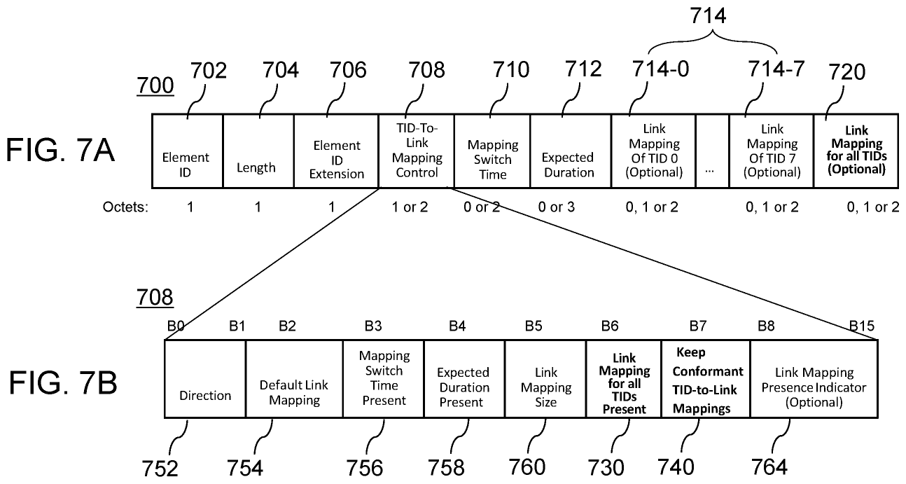

FIG. 7A is an example field format of a TID-To-Link Mapping element 700 for indicating mapping information, according to an example implementation of the present disclosure. FIG. 7B is an example field format of a TID-to-Link Mapping Control field 708 of the TID-To-Link Mapping element 700, according to an example implementation of the present disclosure. As shown in FIG. 7A, the TID-To-Link Mapping element 700 includes fields of Element ID 702, Length 704, Element ID Extension 706, TID-To-Link Mapping Control 708, Mapping Switch Time 710, Expected Duration 712, and/or Link Mapping Of TID 714 (e.g., including Link Mapping Of TID 0 (Optional) 714-0, . . . Link Mapping Of TID 7 (Optional) 714-7). As shown in FIG. 7B, the TID-to-Link Mapping Control field 708 includes subfields of Direction 752, Default Link Mapping 754, Mapping Switch Time Present 756, Expected Duration Present 758, Link Mapping Size 760, and/or Link Mapping Presence Indicator (Optional) 764. At least one of the fields or the subfields may be omitted. The TID-To-Link Mapping element 700 and the TID-to-Link Mapping Control field 708 are non-limiting examples. As shown in FIG. 7A, in some embodiments, the TID-To-Link Mapping element 700 can additionally include a field of Link Mapping for all TIDs (Optional) 720 (e.g., compared to the TID-to-Link Mapping Control field 500). As shown in FIG. 7B, in some embodiments, the TID-to-Link Mapping Control field 708 of the TID-To-Link Mapping element 700 can additionally include a subfield of Keep Conformant TID-to-Link Mappings 740 (e.g., compared to the TID-to-Link Mapping Control field 508) and a subfield of Link Mapping for all TIDs Present 730. For example, a reserved subfield (e.g., the Reserved subfield 562) can be further specified and/or configured to serve as the Keep Conformant TID-to-Link Mappings subfield 740.

The fields and/or subfields discussed herein can be configured in various manners to enhance an indication of the mapping information in a Beacon frame. In some embodiments, as shown in FIG. 7A and FIG. 7B, at least one of the TID-To-Link Mapping Control field 708 or the Keep Conformant TID-to-Link Mappings subfield 740 can be configured, reconfigured, and/or added to enhance an indication of the mapping information in a Beacon frame. For example, at least one of the TID-To-Link Mapping Control field 708 or the Keep Conformant TID-to-Link Mappings subfield 740 can be configured to enhance an indication of the mapping information in a Beacon frame in response to a disabled wireless link.

In some embodiments, the Keep Conformant TID-to-Link Mappings subfield 740 may include control information about whether to renegotiate a mapping. For example, the Keep Conformant TID-to-Link Mappings subfield 740 can include whether to renegotiate a mapping when there is a potential conflict in negotiating, by a device (e.g., STA-1 421-1), with multiple APs. For example, the device (e.g., AP-1 411-1) can set the Keep Conformant TID-to-Link Mappings subfield 740 (e.g., a bit) to “1” to cause a device (e.g., STA-1 421-1) receiving the Beacon frame to maintain a TID-to-link mapping that has been previously negotiated with an AP (e.g., another AP, an AP different than 411-1) and does not conflict with the TID-to-link mapping indicated by the Link Mapping for all TIDs field 720.

In some embodiments, the device (e.g., AP-1 411-1) can disable a wireless link among the plurality of wireless link (e.g., Link 1 430-1, . . . , Link k 430-k), and can set a bit, among the plurality of bits (e.g., in the field for Link Mapping for all TIDs 720), corresponding to the disabled wireless link to indicate that no TIDs are mapped to the disabled wireless link. For example, the corresponding bit can be set to “0” to indicate that no TIDs are mapped to the disabled wireless link. In this case, the device (e.g., AP-1 411-1) can set the Keep Conformant TID-to-Link Mappings subfield 740 to “1” to cause a device (e.g., STA-1 421-1) receiving the Beacon frame to maintain a TID-to-link mapping on remaining wireless links that do not include the disabled wireless link. In some embodiments, the device (e.g., AP-1 411-1) can set the Keep Conformant TID-to-Link Mappings subfield 740 to “1” to cause a device (e.g., STA-1 421-1) receiving the Beacon frame to maintain, after a link is disabled, all mapping that is compatible (e.g., does not include the disabled link), conformant, and/or previously individually negotiated. For example, the device (e.g., STA-1 421-1) can maintain a mapping that is conformant to or is not in conflict with a global mapping indicated by the device (e.g., mapping indicated by Link Mapping for all TIDs 720), instead of adopting the global mapping in the Beacon and renegotiating a TID-to-link mapping (e.g., renegotiating to determine values of Link Mapping Of TID n subfields). In some embodiments, the Beacon frame with the Keep Conformant TID-to-Link Mappings subfield 740 set to “1” can cause the device (e.g., STA-1 421-1) receiving the Beacon frame not to renegotiate a TID-to-link mapping with an AP (e.g., another AP, an AP different than 411-1).

In some embodiments, the Keep Conformant TID-to-Link Mappings subfield 740 may include control information to renegotiate a mapping. For example, the Keep Conformant TID-to-Link Mappings subfield 740 can be set to renegotiate a mapping when there is a potential conflict in negotiating, by a device (e.g., STA-1 421-1), with multiple APs. For example, the device (e.g., AP-1 411-1) can set the Keep Conformant TID-to-Link Mappings subfield 740 (e.g., a bit) to “0” to cause a device (e.g., STA-1 421-1) receiving the Beacon frame to renegotiate a TID-to-link mapping.

In some embodiments, the device (e.g., AP-1 411-1) can disable a wireless link among the plurality of wireless link (e.g., Link 1 430-1, . . . , Link k 430-k), and can set a bit, among the plurality of bits (e.g., in the field for Link Mapping for all TIDs 720), corresponding to the disabled wireless link to indicate that no TIDs are mapped to the disabled wireless link. For example, the corresponding bit can be set to “0” to indicate that no TIDs are mapped to the disabled wireless link. In this case, the device (e.g., AP-1 411-1) can set the Keep Conformant TID-to-Link Mappings subfield 740 to “0” to cause a device (e.g., STA-1 421-1) receiving the Beacon frame to renegotiate a TID-to-link mapping (e.g., Link Mapping of TID n subfields) with an AP (e.g., another AP, an AP different than 411-1) based on the TID-to-link mapping indicated by the Link Mapping for all TIDs field 720. In other words, the Beacon frame with the Keep Conformant TID-to-Link Mappings subfield 740 set to “0” can cause the device (e.g., STA-1 421-1) receiving the Beacon frame to adopt the global mapping in the Beacon (e.g., the mapping indicated by the Link Mapping for all TIDs field 720) and/or renegotiate a TID-to-link mapping (e.g., renegotiating to determine values of Link Mapping Of TID n subfields) based on the global mapping in the Beacon (e.g., removal of a wireless link).

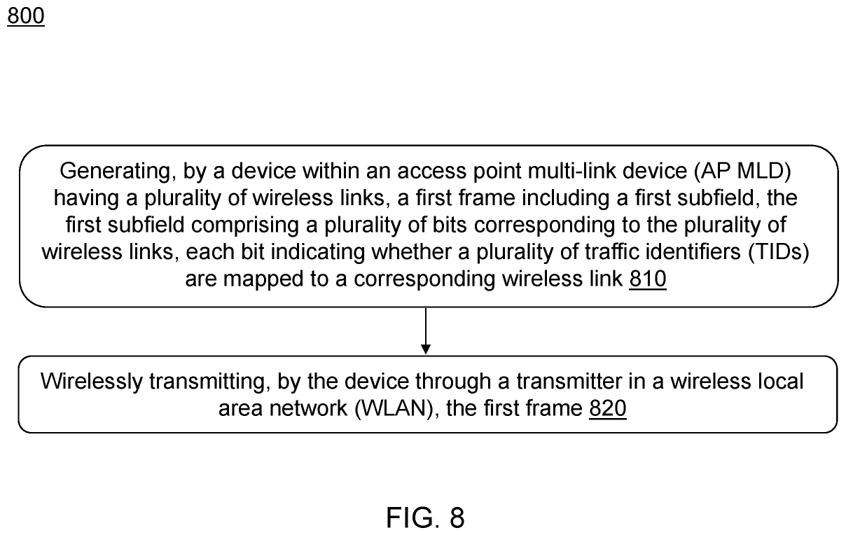

FIG. 8 is a flowchart showing a method 800 of indicating mapping information, according to an example implementation of the present disclosure. In some embodiments, the method 800 is performed by a device within an access point multi-link device (e.g., AP-1 of AP MLD 410) having a plurality of wireless links (e.g., link 430-1, . . . , link 430-k). In some embodiments, the method 800 may be performed by other entities. In some embodiments, the method 800 includes more, fewer, or different steps than shown in FIG. 8.

The method 800 can include generating, by a device (e.g., AP-1 411-1) within an access point multi-link device (AP MLD) having a plurality of wireless links (e.g., link 430-1, . . . , link 430-k), a first frame including a first subfield (e.g., the Link Mapping for all TIDs (Optional) field 620), the first subfield including a plurality of bits corresponding to the plurality of wireless links, each bit indicating whether a plurality of traffic identifiers (TIDs) are mapped to a corresponding wireless link (e.g., step 810 of the method 800). The method can include wirelessly transmitting, by the device through a transmitter in a wireless local area network (WLAN), the first frame (e.g., 820 of the method 800).

In some embodiments, the first subfield may be included in a TID-to-link mapping information element (IE) (e.g., the TID-To-Link Mapping element 600). In some embodiments, the first subfield may have a size of one octet representing a TID-to-link mapping for 8 wireless links, or a size of two octets representing a TID-to-link mapping for 16 wireless links.

In some embodiments, in generating the first frame (e.g., step 810 of the method 800), the method 800 may include the device enabling a wireless link among the plurality of wireless links, and/or setting a bit, among the plurality of bits, corresponding to the enabled wireless link to a first value (e.g., “1”), which can indicate that one or more of the plurality of TIDs are mapped to the enabled wireless link.

In some embodiments, in generating of the first frame (e.g., step 810 of the method 800), the method 800 may include the device setting a bit among the plurality of bits, the bit corresponding to a wireless link among the plurality of wireless links, to a second value (e.g., “0”), indicating that no TIDs are mapped to the wireless link, wherein setting the bit to the second value is to disable the wireless link.

In some embodiments, the method 800 can include the device (e.g., AP-1 411-1) generating a Beacon frame (e.g., the TID-To-Link Mapping element 600) to indicate whether a plurality of TIDs are mapped to a plurality of wireless links (e.g., the k links in FIG. 4). For example, the Beacon frame can include a field (e.g., the Link Mapping for all TIDs field 620) including a plurality of bits corresponding to the plurality of wireless links, respectively. Each bit can indicate whether one or more of the TIDs are mapped to a wireless link corresponding to the bit. For example, the method 800 can include the device setting a first bit of the plurality of bits in the field to “1,” when one or more of the TIDs are mapped to a first link (e.g., Link 1 430-1). For example, the method 800 can include the device setting the first bit of the plurality of bits in the field to “0,” when none of the TIDs is mapped to the first link (e.g., Link 1 430-1). For example, the method 800 can include the device setting a k-th bit of the plurality of bits in the field to “1” when one or more of the TIDs are mapped to a k-th link (e.g., Link k 430-k). For example, the method 800 can include the device setting the k-th bit of the plurality of bits in the field to “0” when none of the TIDs is mapped to the k-th link (e.g., Link k 430-k). In some embodiments, the method 800 can include the device setting each bit to “0” or “1” in response to a status of a corresponding link. For example, the method 800 can include the device setting a corresponding bit to a new value when a status of a link changes. For example, when a link is enabled, a corresponding bit can be set to “1.” For example, a link can be disabled, by setting a corresponding bit to “0.”

In some embodiments, the second subfield may include a second bit (e.g., the Keep Conformant TID-to-Link Mappings subfield 740). The method 800 may include the device setting the second bit to 1 to cause a device receiving the first frame to maintain a TID-to-link mapping that has been previously negotiated with an AP and that does not conflict with the TID-to-link mapping indicated by the first subfield.

In some embodiments, in generating the first frame (e.g., step 810 of the method 800), the method 800 may include the device disabling a wireless link among the plurality of wireless links, setting a bit, among the plurality of bits, corresponding to the disabled wireless link to indicate that no TIDs are mapped to the disabled wireless link, and/or setting the second bit to 1 to cause the device receiving the first frame to maintain a TID-to-link mapping on remaining wireless links that do not include the disabled wireless link.

In some embodiments, the first frame (e.g., Beacon frame) may cause the device receiving the first frame to not renegotiate a TID-to-link mapping with the AP. In some embodiments, the method 800 can include the device (e.g., AP-1 411-1) disabling a wireless link among the plurality of wireless link (e.g., Link 1 430-1, . . . , Link k 430-k), and/or setting a bit, among the plurality of bits (e.g., in the field for Link Mapping for all TIDs 720), corresponding to the disabled wireless link to indicate that no TIDs are mapped to the disabled wireless link. For example, the method 800 can include the device setting the corresponding bit to “0” to indicate that no TIDs are mapped to the disabled wireless link. In this case, the method 800 can include the device (e.g., AP-1 411-1) setting the second bit (e.g., Keep Conformant TID-to-Link Mappings subfield 740) to “1” to cause a device (e.g., STA-1 421-1) receiving the Beacon frame to maintain a TID-to-link mapping on remaining wireless links that do not include the disabled wireless link. In some embodiments, the method 800 can include the device (e.g., AP-1 411-1) setting the second bit (e.g., the Keep Conformant TID-to-Link Mappings subfield 740) to “1” to cause a device (e.g., STA-1 421-1) receiving the Beacon frame to maintain, after a link is disabled, all mapping that is compatible, conformant (e.g., does not include the disabled link), and/or previously individually negotiated. For example, the device (e.g., STA-1 421-1) can maintain a mapping that is conformant to or is not in conflict with a global mapping indicated by the device (e.g., mapping indicated by Link Mapping for all TIDs 720), instead of adopting the global mapping in the Beacon and renegotiating a TID-to-link mapping (e.g., renegotiating to determine values of Link Mapping Of TID n subfields). In some embodiments, the Beacon frame with the Keep Conformant TID-to-Link Mappings subfield 740 set to “1” can cause the device (e.g., STA-1 421-1) receiving the Beacon frame to not renegotiate a TID-to-link mapping with an AP (e.g., another AP, an AP different than 411-1).

In some embodiments, in generating the first frame (e.g., step 810 of the method 800), the method may include the device disabling a wireless link among the plurality of wireless links, setting a bit, among the plurality of bits, corresponding to the disabled wireless link to indicate that no TIDs are mapped to the disabled wireless link, and/or setting the second bit to 0 (e.g., to cause the device receiving the first frame to renegotiate a TID-to-link mapping with the AP, based on the TID-to-link mapping indicated by the first subfield).

In some embodiments, the method 800 can include the device (e.g., AP-1 411-1) setting the second bit (e.g., the Keep Conformant TID-to-Link Mappings subfield 740) to renegotiate a mapping when there is a potential conflict in negotiating, by a device (e.g., STA-1 421-1), with multiple APs. For example, the method 800 can include the device (e.g., AP-1 411-1) setting the second bit (e.g., the Keep Conformant TID-to-Link Mappings subfield 740) to “0” to cause a device (e.g., STA-1 421-1) receiving the Beacon frame to renegotiate a TID-to-link mapping.

In some embodiments, the method 800 can include the device (e.g., AP-1 411-1) disabling a wireless link among the plurality of wireless link (e.g., Link 1 430-1, . . . , Link k 430-k), and/or setting a bit, among the plurality of bits (e.g., in the field for Link Mapping for all TIDs 620), corresponding to the disabled wireless link to indicate that no TIDs are mapped to the disabled wireless link. For example, the method 800 can include the device (e.g., AP-1 411-1) setting the corresponding bit to “0” to indicate that no TIDs are mapped to the disabled wireless link. In this case, the method 800 can include the device (e.g., AP-1 411-1) setting the second bit (e.g., the Keep Conformant TID-to-Link Mappings subfield 740) to “0” to cause a device (e.g., STA-1 421-1) receiving the Beacon frame to renegotiate a TID-to-link mapping (e.g., Link Mapping Of TID n subfields) with an AP (e.g., another AP, an AP different than 411-1) based on the TID-to-link mapping indicated by the first subfield (e.g., the Link Mapping for all TIDs field 720). In other words, the Beacon frame with the Keep Conformant TID-to-Link Mappings subfield 740 set to “0” can cause the device (e.g., STA-1 421-1) receiving the Beacon frame to adopt the global mapping in the Beacon (e.g., the mapping indicated by the Link Mapping for all TIDs field 720) and renegotiate a TID-to-link mapping (e.g., renegotiating to determine values of Link Mapping Of TID n subfields) based on the global mapping in the Beacon (e.g., removal of a wireless link).

### 5. Advantages

Embodiments in the present disclosure have at least the following advantages and benefits. First, embodiments in the present disclosure can provide useful techniques for enhancing an indication of mapping information. As discussed above, the techniques disclosed herein can reduce a size of a Beacon frame, and thus a size of an overhead. This can prevent channel congestion, especially in scenarios with many APs, thereby improving power efficiency and an overall network throughput. In addition, by reducing the Beacon frame size, interop issues for legacy devices can be avoided.

Second, embodiments in the present disclosure can provide useful techniques for reducing a size of a TID-to-Link Mapping element in a Beacon frame for use cases. As discussed above, the techniques disclosed herein can be utilized to reduce a size of a TID-to-Link Mapping element in a Beacon frame when a link is enabled/disabled. For example, the techniques disclosed herein allow for the size to be reduced (e.g., can save from 8 to 15 octets) to indicate mapping information while a link is enabled/disabled. This can thereby reduce a networking signaling overhead of renegotiating an individual TID-to-Link mapping for non-AP MLDs, while reducing an impact on network performance as a result of the link disablement.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A device within an access point multi-link device (AP MLD) having a plurality of wireless links, the device comprising:
one or more processors configured to:
generate a first frame including a first subfield, the first subfield comprising a plurality of bits corresponding to the plurality of wireless links, each bit indicating whether a plurality of traffic identifiers (TIDs) are mapped to a corresponding wireless link; and
wirelessly transmit, through a transmitter in a wireless local area network (WLAN), the first frame.

2. The device according to claim 1, wherein the first subfield is included in a TID-to-link mapping information element (IE).

3. The device according to claim 1, wherein the first subfield has a size of one octet representing a TID-to-link mapping for 8 wireless links, or a size of two octets representing a TID-to-link mapping for 16 wireless links.

4. The device according to claim 1, wherein in generating the first frame, the one or more processors are configured to:
enable a wireless link among the plurality of wireless links; and
set a bit, among the plurality of bits, corresponding to the enabled wireless link to a first value, indicating that one or more of the plurality of TIDs are mapped to the enabled wireless link.

5. The device according to claim 1, wherein in generating the first frame, the one or more processors are configured to:
set a bit among the plurality of bits, the bit corresponding to a wireless link among the plurality of wireless links, to a second value, indicating that no TIDs are mapped to the wireless link,
wherein setting the bit to the second value is to disable the wireless link.

6. The device according to claim 1, wherein the first subfield is present when a first bit is set to 1, and wherein the first frame has a second subfield including the first bit.

7. The device according to claim 6, wherein
the second subfield includes a second bit; and
the one or more processors are configured to set the second bit to 1 to cause a device receiving the first frame to maintain a TID-to-link mapping that has been previously negotiated with an AP and does not conflict with the TID-to-link mapping indicated by the first subfield.

8. The device according to claim 7, wherein in generating the first frame, the one or more processors are configured to:
disable a wireless link among the plurality of wireless links;
set a bit, among the plurality of bits, corresponding to the disabled wireless link to indicate that no TIDs are mapped to the disabled wireless link; and
set the second bit to 1 to cause the device receiving the first frame to maintain a TID-to-link mapping on remaining wireless links that do not include the disabled wireless link.

9. The device according to claim 8, wherein the first frame causes the device receiving the first frame not to renegotiate a TID-to-link mapping with the AP.

10. The device according to claim 7, wherein in generating the first frame, the one or more processors are configured to:
disable a wireless link among the plurality of wireless links;
set a bit, among the plurality of bits, corresponding to the disabled wireless link to indicate that no TIDs are mapped to the disabled wireless link; and
set the second bit to 0 to cause the device receiving the first frame to renegotiate a TID-to-link mapping with the AP based on the TID-to-link mapping indicated by the first subfield.

11. A method comprising:
generating, by a device within an access point multi-link device (AP MLD) having a plurality of wireless links, a first frame including a first subfield, the first subfield comprising a plurality of bits corresponding to the plurality of wireless links, each bit indicating whether a plurality of traffic identifiers (TIDs) are mapped to a corresponding wireless link; and
wirelessly transmitting, by the device through a transmitter in a wireless local area network (WLAN), the first frame.

12. The method according to claim 11, wherein the first subfield is included in a TID-to-link mapping information element (IE).

13. The method according to claim 11, wherein the first subfield has a size of one octet representing a TID-to-link mapping for 8 wireless links, or a size of two octets representing a TID-to-link mapping for 16 wireless links.

14. The method according to claim 11, wherein generating the first frame comprises:
enabling a wireless link among the plurality of wireless links; and
setting a bit, among the plurality of bits, corresponding to the enabled wireless link to a first value, indicating that one or more the plurality of TIDs are mapped to the enabled wireless link.

15. The method according to claim 11, wherein generating the first frame comprises:
setting a bit among the plurality of bits, the bit corresponding to a wireless link among the plurality of wireless links, to a second value, indicating that no TIDs are mapped to the wireless link,
wherein setting the bit to the second value is to disable the wireless link.

16. The method according to claim 11, wherein the first subfield is present when a first bit is set to 1, and wherein the first frame has a second subfield including the first bit.

17. The method according to claim 16, wherein
the second subfield includes a second bit; and
the method further comprises:
setting the second bit to 1 to cause a device receiving the first frame to maintain a TID-to-link mapping that has been previously negotiated with an AP and does not conflict with the TID-to-link mapping indicated by the first subfield.

18. The method according to claim 17, wherein generating the first frame comprises:
disabling a wireless link among the plurality of wireless links;
setting a bit, among the plurality of bits, corresponding to the disabled wireless link to indicate that no TIDs are mapped to the disabled wireless link; and
setting the second bit to 1 to cause the device receiving the first frame to maintain a TID-to-link mapping on remaining wireless links that do not include the disabled wireless link.

19. The method according to claim 18, wherein the first frame causes the device receiving the first frame not to renegotiate a TID-to-link mapping with the AP.

20. The method according to claim 17, wherein generating the first frame comprises:
disabling a wireless link among the plurality of wireless links;
setting a bit, among the plurality of bits, corresponding to the disabled wireless link to indicate that no TIDs are mapped to the disabled wireless link; and
setting the second bit to 0 to cause the device receiving the first frame to renegotiate a TID-to-link mapping with the AP based on the TID-to-link mapping indicated by the first subfield.
